(19) United States
(12) Patent Application Publication
(10) Pub. No.: US 2005/0175344 A1
(43) Pub. Date: Aug. 11, 2005

(54) System and apparatus for a carrier class WDM PON accommodating multiple services or protocols

(75) Inventors: William X. Huang, San Ramon, CA (US); Jer-Chen Kuo, Davis, CA (US); Ten-Ling Ti, San Jose, CA (US); Liming Gao, Alameda, CA (US); Weizhong Tang, Castro Valley, CA (US)

Correspondence Address: FELIX L. FISCHER, ATTORNEY AT LAW, 1607 MISSION DRIVE, SUITE 204, SOLVANG, CA, 93463, US

(73) Assignee: UTStarcom, Inc.

(21) Appl. No.: 11/011,274

(22) Filed: Dec. 13, 2004

Related U.S. Application Data
(60) Provisional application No. 60/542,508, filed on Feb. 6, 2004.

(51) Int. Cl. H04J 14/02

(52) U.S. Cl. 398/79

(57) ABSTRACT

A Passive Optical Network (PON) is provided with capability for multiple protocols and service suppliers by employing Wavelength Division Multiplexer (WDM) elements in combination with optical couplers at optical distribution nodes (ODN) intermediate a local exchange office and a customer node. The local exchange office node transmitting and receiving signals from a single optical fiber through a WDM providing M/2 wavelength pairs for use with differing protocols and each customer node connected to one leg of an optical coupler in the ODN with a WDM associated with one of the wavelength pairs for received and transmitted signals.

### CROSS-REFERENCE TO RELATED APPLICATIONS

This application claims priority of Provisional Application Ser. No. 60/542,508 filed on Feb. 06, 2004 entitled System and Apparatus for a Carrier Class WDM PON Accommodating Multiple Services or Protocols.

### BACKGROUND OF THE INVENTION

1. Field of the Invention

This invention relates generally to the field of telecommunications network transmission systems and, more particularly, to a wavelength division multiplexing Passive Optical Network (PON) that provides access to multiple services on a single fiber optic cable through the combination of Wavelength Division Multiplexer (WDM) elements and optical coupler elements.

2. Description of the Related Art

Existing Passive Optical Networks are commonly found in use for broadband fiber optic access network. The PON uses a means of sharing fiber to the home without running individual fiber optic lines from an exchange point, telephone company local exchange office (LEO) or a CATV Headend to the subscriber's home.

In a Passive Optical Network as known in the current art there is only a single point of connection at a Point of Interface (POI). So the user is not able to switch service provider and multiple service providers can't insert a service circuit at the POI. A challenge for existing Passive Optical Networks is to increase the number service providers sharing with one fiber whether in a bus or loop configuration. This is required to allow an unbundled service local loop with regulatory compliance in a Passive Optical Network. It is therefore desirable to provide an unbundled local loop in which the user has the freedom to select the service provider at an Exchange Office Point of Interface. It is further desirable for point-to-point fiber local loop to provide the ability for service provider to insert a service circuit at the POI to satisfy user requests.

Further, a problem with existing products is the multiple standards of bit rate and transport protocol in the Passive Optical Network. There are TDM, ATM and Ethernet from different standard bodies such as ITU (TDM and ATM) and IEEE (Ethernet). As the technology keeps forcing the bit rate higher, the ability to provide a migration method for new protocols while continuing to support the legacy protocol becomes a challenge. It is therefore desirable to provide a PON which accommodates multiple protocols simultaneously.

### SUMMARY OF THE INVENTION

A Passive Optical Network (PON) is enhanced by providing an exchange office having a first Wavelength Division Multiplexer (WDM) with M channels for transmission of M/2 wavelength pairs with an optical fiber connected to the WDM. A 1×N optical coupler is connected to the optical fiber and N customer nodes are each connected through a WDM to a leg of the coupler to receive a respective one of the M/2 wavelength pairs.

M/2 protocols are each transmitted using a respective one of the M/2 wavelength pairs or M/2 service providers each provide service over a respective one of the M/2 wavelength pairs.

### BRIEF DESCRIPTION OF THE DRAWINGS

These and other features and advantages of the present invention will be better understood by reference to the following detailed description when considered in connection with the accompanying drawings wherein:

FIGS. 1a-e are block diagrams showing the various PON configurations in which the present invention can be employed;

FIG. 2a is a block diagram illustrating the current connection requirements for a PON with single service provider connection at the POI;

FIG. 2b is a block diagram demonstrating a PON employing the elements of a system embodying the present invention for use with multiple service providers connecting at the POI; and,

FIG. 3 is a block diagram of the elements of a system embodying the present invention.

### DETAILED DESCRIPTION OF THE INVENTION

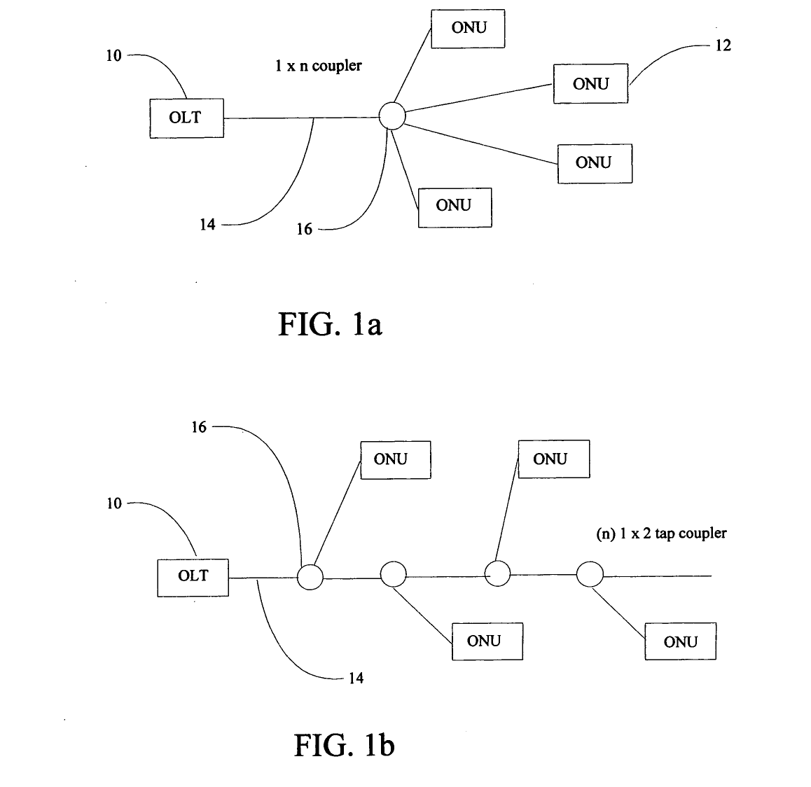

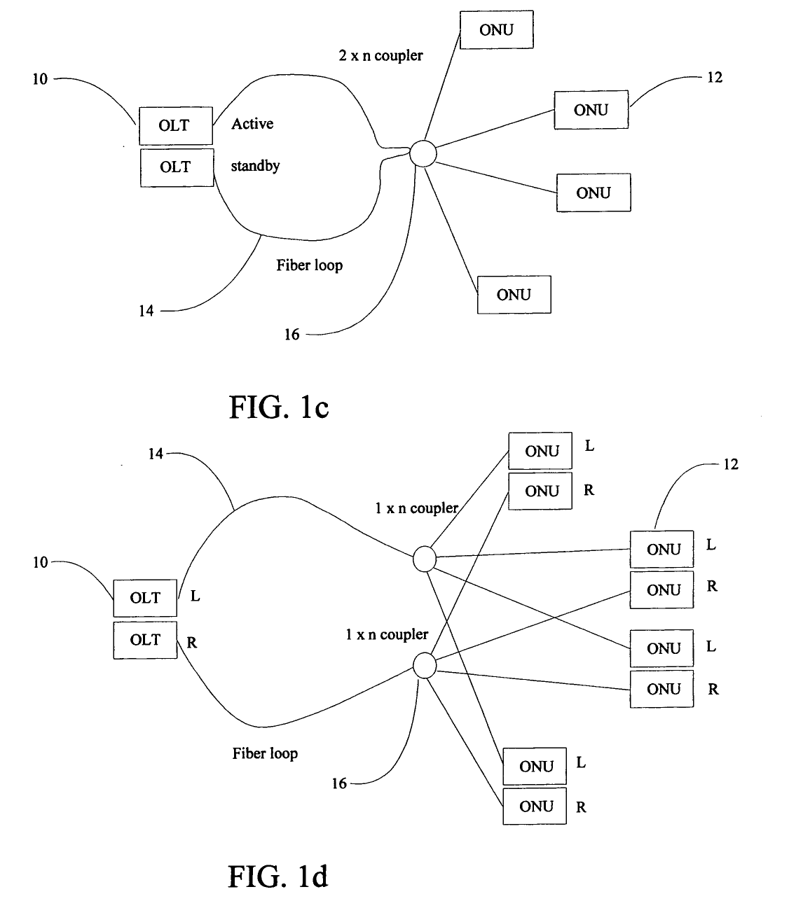

Referring to FIGS. 1a-e, a passive optical network (PON) is a system that brings Optical Fiber cabling and signals all or most of the way to the end user. Depending on where the PON terminates, the system can be described as fiber-to-the-curb (FTTC), fiber-to-the-building (FTTB), or fiber-to-the-home (FTTH). A PON consists of an Optical Line Termination (OLT) 10 at the communication company's local exchange office and a number of Optical Network Units (ONUs) 12 near end users. Typically, up to 32 ONUs can be connected to an OLT. The term “passive” simply describes the fact that optical transmission has no power requirements or active electronic parts once the signal is going through the network. The main components in PON are Optical Fiber 14 and Couplers 16. Each coupler combines or splits power from optical fibers. It is used in the PON to distribute optical signal to and from multiple subscriber lines.

FIG. 1a discloses a PON with a basic tree structure wherein the ONUs are connected to the OLT through one 1×n coupler from a single optical fiber to a branch optical fiber for each ONU. FIG. 1b discloses a bus structure in which each ONU has a separate coupler (n 1×2 couplers) on a single optical fiber “bus”.

FIG. 1c discloses a PON with a trunk protected tree wherein two OLTs are present on a fiber optic loop with one OLT active and one standby. The coupler is a 2×n to accommodate the two “halves” of the loop connecting with the OLTs. FIG. 1d discloses a fully redundant tree with two OLTs, as in the trunk protected tree, with a 1×n coupler at the termination point of the fiber optic loop and each user location has two ONUs, one communicating through each of the couplers to the respective live or redundant OLT.

FIG. 1e shows a fully redundant bus architecture with two OLTs and two ONUs at each user location connected to the fiber loop bus through a 2×2 coupler.

A PON employing the present invention allow shared costs of fiber and much of the equipment located with the service provider among several customers, while also eliminating expensive, powered equipment between the service provider and these customers. The optical path is “transparent” to bit rate, modulation format (e.g., digital or analog), and protocol (e.g., SONET/SDH, ATM, Ethernet). Such transparency results from nothing being installed between the service provider and the customer which is specific to the bit rate, modulation format, etc., allowing services to be mixed or economically upgraded in the future as needed. New services and/or new customers can be added by changing service-specific equipment only at the ends of the network, and only for those customers affected. Such flexibility is not the case in most of today's other access network architectures.

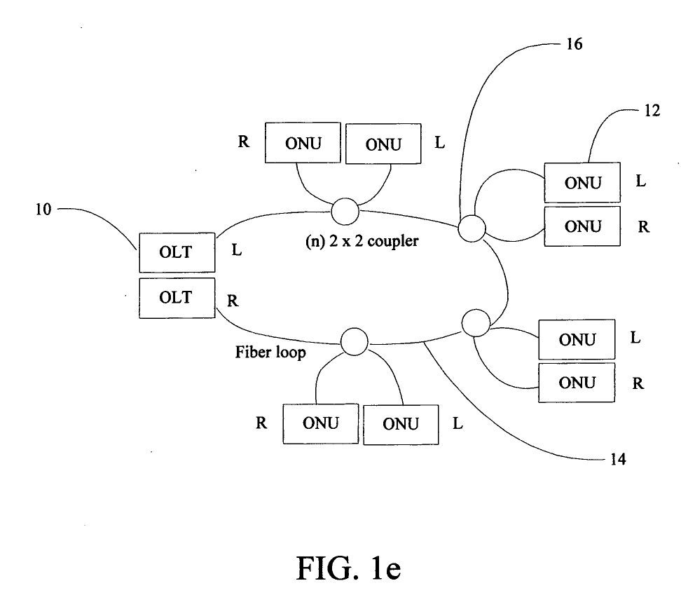

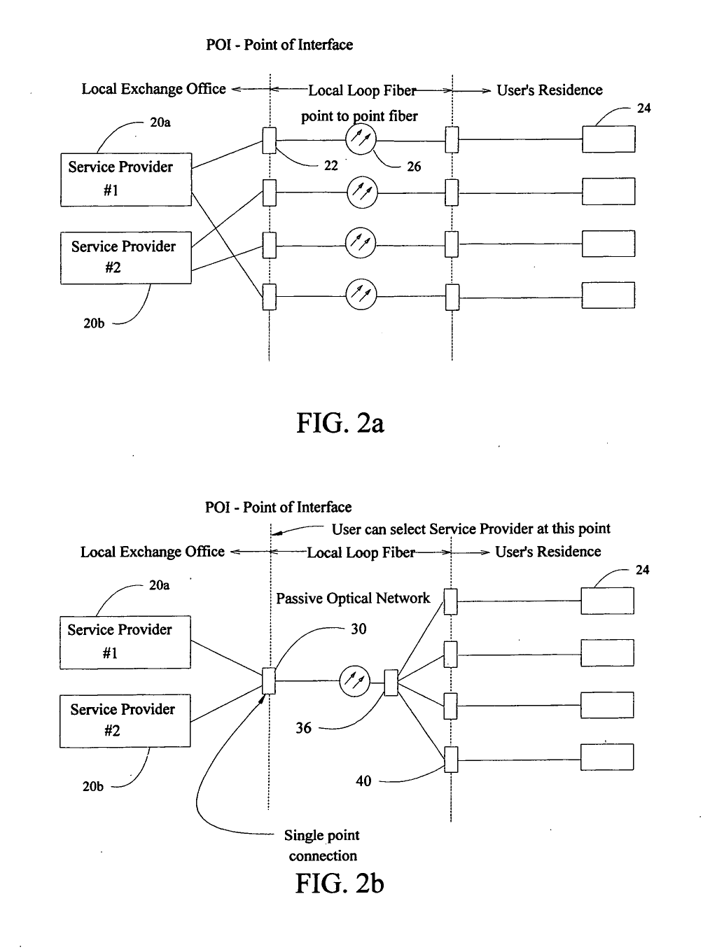

As shown in FIG. 2a for system employing current state of the art PONs, the service providers 20a and 20b each connect separately through a Point of Interface (POI) 22 to individual customer 24. A separate local loop fiber 26 is required to accommodate the differing system requirements.

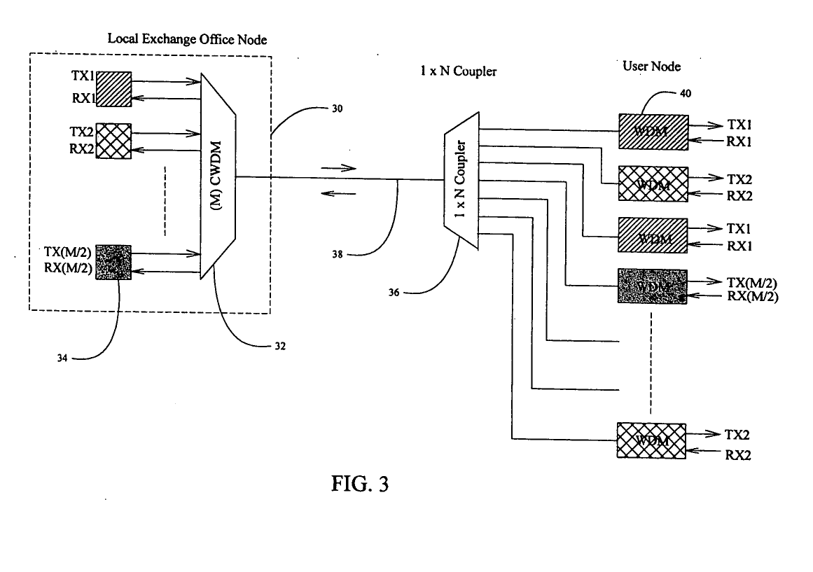

Wavelength Division Multiplexers (WDM) allow several signals to be sent through one optical fiber with different wavelengths of light to avoid interference in the signals. Referring to FIG. 3, in an Local Exchange Office (LEO) 30, which can constitute the OLT for the PON as described above, the present invention employs a WDM 32 having M channels for multiplexing M wavelengths. This allows M/2 types of protocol to be mixed in one PON, carried in M/2 wavelength pairs. As an example of an eight wavelength system, pairs of (1470/1550 nm), (1490/1570 nm), (1510/1590 nm), (1530/1610 nm) are provided. The protocols can be APON, BPON, EPON and GPON. The embodiment also allows M/2 service providers to insert service circuits in the PON fiber. In the LEO site, each service provider can use different wavelength pair for service. The differing service providers or protocol systems are designated as elements 34 in FIG. 3.

An exemplary WDM employed in intended embodiments of the invention as described for the LEO is manufactured by Optowaves, Inc. 780 Montague Expressway, Suite 403, San Jose, Calif. 95131 with part number CWDM-8-14-1-SC/UPC.

A 1×N coupler 36 allows the multiplexed wavelength signal to be split from the optical fiber 38 for distribution to N Customer Nodes 40 which comprises a WDM. A customer then selects the desired service provider by a “color specific” determination in the WDM provided by the service provider; as an example 1490/1310 nm band for Service Provider 1 and 1610/1550 nm band for Service Provider 2. Exemplary hardware for this application would be a 1490/1310 two channel WDM and 1610/1550 two channel WDM. Each provider uses a wavelength pair, one for transmit another one receive. For M wavelength system, a total of M/2 pairs can be assigned. The invention uses WDM to multiplex M wavelengths into a single optical fiber. The fiber is brought in the local loop and split N ways to N Customer Nodes. The implementation of the present invention is shown in FIG. 2b for two service providers as an example for comparison with the convention PON shown in FIG. 2a.

In the multiple protocol application, each wavelength pair can be assigned to a protocol. The Customer Node is “color selected” to the specific protocol carried in the assigned wavelength pair. This allows multiple protocols running simultaneously in the single optical fiber of the Passive Optical Network. The invention therefore provides the ability for migration of upgrading the Passive Optical Network system with a new protocol while supporting the legacy protocol in the network.

In unbundled local loop application, each wavelength pair can be assigned to a service provider. Customer Node is “color selected” to the desired Service Provider. This allows user to select a service provider in the Passive Optical Network or multiple service providers to share the same Passive Optical Network infrastructure. This creates service competition that benefit user to get better and lower cost services. The Network Operator will save cost for fiber infrastructure and Service Provider can significantly save the cost of reaching new users and deploying new service based on shared WDM PON infrastructure.

Having now described the invention in detail as required by the patent statutes, those skilled in the art will recognize modifications and substitutions to the specific embodiments disclosed herein. Such modifications are within the scope and intent of the present invention as defined in the following claims.

1. A Passive Optical Network (PON) comprising:
a local exchange office having a first Wavelength Division Multiplexer (WDM) with M channels for transmission of M/2 wavelength pairs;
an optical fiber connected to the WDM;
a 1×N optical coupler connected to the optical fiber, and
N customer nodes, each having a WDM connected to a leg of the coupler to receive a respective one of the M/2 wavelength pairs.

2. A Passive Optical Network as defined in claim 1 wherein M/2 protocols are each transmitted using a respective one of the M/2 wavelength pairs.

3. A Passive Optical Network as defined in claim 1 wherein M/2 service providers each provide service over a respective one of the M/2 wavelength pairs.

4. A method for providing multiple protocol capability in a Passive Optical Network comprising the steps of:
providing an optical fiber as a communication medium;
providing a local exchange office Wavelength Division Multiplexer (WDM) with M channels;
assigning M/2 channel pairs for communication of selected protocols;
providing an optical coupler connected to the optical fiber;
providing a plurality of customer nodes connected to the optical coupler, each having a WDM for communication; and,
selecting one of the assigned channel pairs through the customer node WDM for communication with the associated protocol.

5. A method as defined in claim 4 wherein the step of assigning further comprises selecting a separate protocol for each of the M/2 channel pairs.

6. A method as defined in claim 5 further comprising the step of assigning selected ones of the M/2 channel pairs for use by service providers for communication over the network with the associated protocol.
